(19) United States
(12) Patent Application Publication
(10) Pub. No.: US 2021/0070270 A1
(43) Pub. Date: Mar. 11, 2021

(54) Improved Braking System and Vehicle Comprising Such a Braking System

(71) Applicant: LOHR ELECTROMECANIQUE, Hangenbieten (FR)

(72) Inventor: Pierre-Charles Glouchkoff, Niedernai (FR)

(21) Appl. No.: 17/040,839

(22) PCT Filed: May 3, 2019
(86) PCT No.: PCT/FR2019/051019

§ 371 Date: Sep. 23, 2020

(30) Foreign Application Priority Data
May 4, 2018 (FR) 1853908

(51) Int. Cl. B60T 13/62; B60T 7/20; B60T 17/00; B60T 13/14; B60T 8/171; B60T 17/22; B60T 7/12; B60T 8/17; B60T 13/66; B60T 7/04

(52) U.S. Cl. CPC B60T 13/62; B60T 7/20; B60T 17/00; B60T 13/14; B60T 8/171; B60T 17/221; B60T 2270/30; B60T 8/1701; B60T 13/66; B60T 7/04; B60T 2270/402; B60T 2270/403; B60T 2270/10; B60T 7/12

(57) ABSTRACT

The invention relates to a motorized road vehicle having a braking system for actuating braking elements assigned to the wheels of said vehicle, and control elements for controlling the operation of the braking system, which system includes a hydraulic manual braking circuit. The invention is characterized in that the braking system comprises a complementary, electrically controlled, hydraulic circuit, and the control elements comprise an electric automatic braking control system for generating main or complementary braking set values, which are transmitted to the complementary hydraulic circuit.

### TECHNICAL FIELD

The present invention relates to the general technical field of braking systems for vehicles. Such braking systems make it possible, via hydraulic circuits, to actuate brake members disposed at the wheels of a vehicle. The present invention relates more particularly to an optimized braking system designed for vehicles that can travel alone or in a convoy in the form of a set of a plurality of coupled-together or “hitched-together” vehicles.

The optimized braking systems of the present invention also relate to “autonomous” or “self-driving” vehicles in which the driving and/or certain functions is/are performed by an automated logic controller. For example, such autonomous vehicles may be devoid of driver stations or cabs. By way of a variant, such autonomous vehicles may have suitable members enabling a driver to take back control over some or all of the functions of the vehicle. This may be useful under certain circumstances for maneuvering said vehicle, in emergencies or in situations of immediate danger.

The invention also relates to optimizing braking systems of vehicles that are hitched together and in which one vehicle constitutes a towing vehicle or “tractor” vehicle and the others hitched to the tractor vehicle are configured in trailer mode.

### SUMMARY OF THE DISCLOSURE

Various braking systems exist for vehicles, but such braking systems are not generally designed and configured to satisfy technically all of the desired applications, namely autonomous vehicles, hitched-together vehicles, or manually driven vehicles. In addition, known braking systems are, in general, unsuitable for satisfying all of the mandatory safety constraints, in particular when the braking system malfunctions.

Furthermore, the very specific development of Anti-lock Braking System (ABS)/Electronic Stability Program (ESP) modules for these types of vehicles is extremely costly.

A braking system for a two-axled vehicle is also known from Document EP 3 103 691. That document more particularly discloses a trailer having braking means that are autonomous, i.e. independent, from the towing vehicle or “tractor”. The braking system that is disclosed comprises two distinct braking circuits, one being fed via a main hydraulic circuit while the other is fed via a hydraulic accumulator. The hydraulic accumulator acts on only one axle in order to implement safety braking. Furthermore, such a system, which is designed for a hitched-together set comprising a vehicle towing a trailer, is not adapted to motor vehicles that are configurable in various different modes of use. The system disclosed in that document cannot satisfy the requirements related to operation of a vehicle that is suitable for being used both in trailer mode and in tractor mode.

An object of the present invention is therefore to mitigate the above-mentioned drawbacks and to provide an optimized braking system guaranteeing operating safety even in the event one or other of the component elements of said braking system fails.

Another object of the present invention is to propose a novel braking system making it possible to equip equally well a vehicle driven manually, an autonomous vehicle, a convoy vehicle configured as a tractor or configured as a trailer, and in particular a vehicle configurable in different modes of operation and/or of use.

Another object of the present invention is to provide an optimized braking system that makes it possible to deliver sufficient braking power, even for vehicles that are relatively heavy, namely vehicles of weight exceeding 3500 kilograms (kg).

Another object of the present invention is to provide a novel braking system that is effective for vehicles in which the braking systems of the ABS and ESP type with an autonomous braking function prove to be insufficient.

Another object of the present invention is to propose a novel vehicle equipped with a novel optimized braking system.

The objects assigned to the present invention are achieved by means of a braking system adapted to a road motor vehicle, an individual vehicle, an autonomous vehicle, or a vehicle configured in trailer mode or in tractor mode, for the purpose of actuating brake members for braking the vehicle that are associated with the wheels of said vehicle, said system comprising control members for controlling operation of it and a manual braking hydraulic circuit, said braking system being characterized in that it further comprises an additional hydraulic circuit equipping the same vehicle and electrically controlled, the control members comprising an electrical braking automated logic controller for generating main or additional braking setpoints, which are transmitted to the additional hydraulic circuit.

In a variant embodiment, the braking system equips a vehicle configurable in trailer mode, in which the additional hydraulic circuit electrically controlled via the braking automated logic controller is activated, said braking automated logic controller being slaved to a master braking automated logic controller of another vehicle.

In a variant embodiment, the braking system further comprises brake fluid separators for making it possible to operate with two different brake fluids.

In a variant embodiment, the additional hydraulic circuit includes at least one accumulator for storing a hydraulic fluid under a hydraulic pressure suitable for implementing the braking operations.

In a variant embodiment, the braking automated logic controller includes analysis and/or comparison members for detecting failure or malfunctioning of the manual braking hydraulic circuit and for generating braking setpoints corresponding to emergency braking of said vehicle by means of the additional braking hydraulic circuit.

In a variant embodiment, the braking system further comprises a set of sensors for measuring values of physical parameters of operation and use of said vehicle, said sensors being connected to the braking automated logic controller for the purposes of transmitting the measured values to it and of automatically generating braking setpoints for the additional hydraulic circuit and of thereby implementing automatic braking.

In a variant embodiment, the manual braking hydraulic circuit includes a manual braking member, of the brake pedal type for actuating the braking, and equipped with a position sensor, which delivers information used for making a comparison with the braking power transmitted to the brake members and for thereby checking the structural integrity of said braking system.

In a variant embodiment, the braking system further comprises a selection member for selecting an autonomous operating mode in which the automatic braking is activated or a manual operating mode in which the manual braking hydraulic circuit is activated.

In a variant embodiment, the manual braking hydraulic circuit and the additional hydraulic circuit are connected to the brake members via a hydraulic “OR” gate making it possible to give priority to the hydraulic circuit that has the higher braking hydraulic pressure.

In an embodiment, the braking system of the invention further comprises a distribution module for distributing the braking hydraulic pressure, the module being of the ABS type and/or of the ESP type.

The objects assigned to the present invention are also achieved by means of a vehicle including a braking system as presented above and that can be configured as an individual vehicle or as an autonomous vehicle.

The objects assigned to the present invention are also achieved by means of an autonomous vehicle including a braking system as presented above.

The objects assigned to the invention are also achieved by a vehicle including a braking system as described above and that can be configured in tractor mode or in trailer mode, in which the additional hydraulic circuit that is electrically controlled via the braking automated logic controller is activated, said braking automated logic controller being slaved to a master braking automated logic controller of another vehicle.

The objects assigned to the present invention are also achieved by means of a convoy of vehicles that are connected together by means of mechanical or intangible hitching-together, said convoy including a tractor vehicle including a braking system as presented above, and at least one vehicle configured in trailer mode as presented above, the braking automated logic controller of the tractor vehicle being connected to the braking automated logic controller of the vehicle configured in trailer mode via a wired or wireless communications link, via which the braking setpoints for said vehicle configured in trailer mode pass.

The braking system of the invention offers the huge advantage of incorporating an automatically controlled braking mode at lower cost, and does so even if the vehicle is not equipped with an ABS/ESP module.

Another advantage of the braking system of the invention lies in the possibility of adjusting the maximum braking power. Indeed, a conventional braking system generally has a master cylinder dimensioned to deliver a maximum braking power that is determined and that is adapted to the weight of the vehicle. The invention makes it possible to adapt the maximum braking power to various constraints related, in particular, to the mode of use of the vehicle or to specific braking performance. Such a possibility of adaptation is very advantageous, in particular when the vehicle is not provided with a braking distributor of the ABS type. By way of example, it is possible, with the braking system of the invention, to reduce substantially the risk of the wheels locking on dry roads while also not degrading the braking performance. The braking system of the invention thus makes it possible to adapt the maximum braking power, for example to the payload or to the braking specificities related to the vehicle being used in trailer mode.

Another advantage of the braking system of the invention lies in the fact that it can equip an existing vehicle and that it is not necessary to replace the original brake calipers of said vehicle.

Another advantage of the braking system of the invention lies in the fact that its additional braking circuit makes it possible, in automatically controlled mode, to deliver more braking power and to do so automatically, when the vehicle is used in manual braking mode. The braking system of the invention can thus mitigate any failures or any lack of alertness of the driver.

Another advantage of the braking system of the invention lies in that fact that it can be integrated easily and reliably into a vehicle that can be configured or reconfigured depending on whether it is used as an individual vehicle, as an autonomous vehicle, or in trailer mode.

The additional hydraulic circuit integrated in the same vehicle as the manual braking hydraulic circuit can, if need be, perform standard braking of the vehicle in ordinary use, and is not reserved for safety braking only.

The braking system of the invention is also advantageous insofar as it can equip vehicles of different types. This constitutes an economic advantage that is appreciable for the manufacturer of such vehicles.

### BRIEF DESCRIPTION OF THE FIGURES

Other characteristics and advantages of the invention appear on reading the following detailed description given by way of non-limiting illustrative example with reference to the accompanying drawings, in which:

FIG. 1 is a block diagram of an embodiment of the braking system of the invention;

FIG. 2 is a detailed hydraulic diagram of a variant embodiment of the braking system of FIG. 1;

FIG. 3a is a detailed hydraulic diagram of another variant embodiment of the braking system of FIG. 1;

FIG. 3b is a detailed hydraulic diagram of another variant embodiment of the braking system of FIG. 1;

FIG. 4 is a block diagram of another embodiment of a braking system of the invention; and

FIG. 5 is a detailed hydraulic diagram of a variant embodiment of the braking system of FIG. 4.

### DETAILED DESCRIPTION OF THE INVENTION

Elements that are shown in more than one of the figures and that are structurally and functionally identical are given the same numerical or alphanumeric references in each of them and in the description below.

The braking systems are described below with reference to various figures relating to various variant embodiments. In these variant embodiments, the hydraulic braking circuits are constituted by two identical half-circuits, in such a manner as to make it possible to implement braking of the vehicle even in the event of a malfunction or of a hydraulic leak on one of the half-circuits.

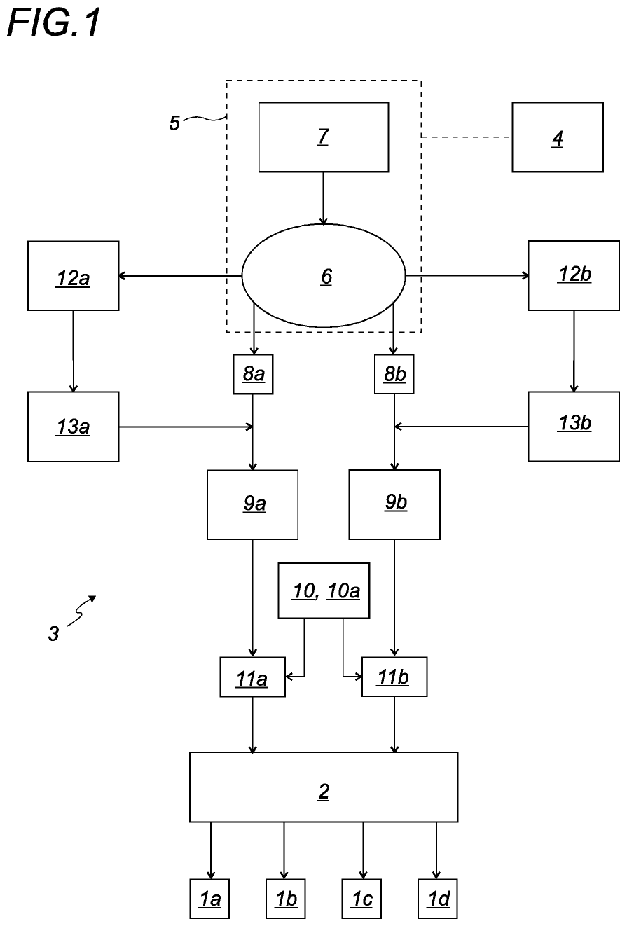

FIG. 1 is a block diagram of an embodiment of a braking system of a vehicle of the invention. In this embodiment, the braking system makes it possible to actuate brake members 1a, 1b, 1c, 1d, which are brake calipers in this example, each of which is associated with a brake disk of a wheel of the vehicle.

The braking setpoints are advantageously transmitted to the brake members 1a, 1b, 1c, 1d via a module for distributing the intensity of the braking 2, which module is of the ABS type and/or of the ESP type. The elements making it possible to achieve this distribution of the braking hydraulic pressure and designed to avoid locking of the wheels and/or to make it possible to perform stability control are optional.

The braking system advantageously includes an additional braking hydraulic circuit 3 that is electrically controlled via a braking automated logic controller 4.

The braking automated logic controller 4 includes electrical and/or electronic components making it possible to implement functions for analyzing and comparing values for physical parameters that are measured by means of sensors disposed on the vehicle.

The braking automated logic controller 4 may also receive braking setpoints and/or information via a wired or wireless link from a braking automated logic controller 4 on another vehicle when the vehicles are hitched together to form a convoy.

The additional hydraulic circuit 3 includes a hydraulic feed subassembly 5. The hydraulic feed subassembly comprises a hydraulic pump 6 connected to a hydraulic fluid reservoir 7, the hydraulic fluid being a mineral oil in this example. The braking automated logic controller 4 advantageously controls operation of the hydraulic pump 6.

The additional hydraulic circuit 3 also includes two inverse proportional hydraulic valves 8a and 8b controlled by the braking automated logic controller 4. Such an inverse proportional valve 8a, 8b is 100% open when it is not electrically powered. The inverse proportional hydraulic valves 8a and 8b make it possible to control a braking intensity respectively on brake members 1a & 1b and on brake members 1c & 1d of two braking half-circuits of the vehicle.

The inverse proportional hydraulic valves 8a and 8b make it possible to feed respective ones of fluid separators 9a and 9b with hydraulic fluid. Each of said fluid separators is advantageously constituted by a master cylinder making it possible firstly to transmit a braking intensity and secondly to use a different brake fluid for actuating the brake members 1a, 1b, 1c, 1d.

The braking system of the invention also includes a manual braking hydraulic circuit 10. For example, this manual braking hydraulic circuit 10 may include a manual actuating member 10a connected to a master cylinder and also connected to selectors 11a and 11b. For example, the selectors 11a and 11b may be constituted by hydraulic valves that are controlled electrically and that make it possible to control a braking intensity for the brake members 1a, 1b, 1c and 1d, either via the main braking hydraulic system 10 or via the additional braking hydraulic circuit 3. Said selectors 11a and 11b make it possible to feed the braking distribution module 2 with hydraulic fluid directly. It is thus possible to select either a manual braking mode by means of the manual braking hydraulic circuit 10, or an automatic braking mode, also referred to as “automatically controlled braking”.

When the selectors 11a and 11b are switched over to the position corresponding to the “manual braking” mode, it is the driver alone who determines the braking intensity via the actuating member 10a.

When the selectors 11a and 11b are switched over to the position corresponding to the “automatically controlled braking” mode, the additional hydraulic circuit 3 transmits a hydraulic pressure to the distribution module 2 by means of the separators 9a and 9b.

For this purpose, the additional hydraulic circuit 3 includes hydraulic energy accumulators 12a and 12b that are suitable or acting on the fluid separators 9a and 9b.

In automatically controlled mode operation, the hydraulic pump 6 feeds the hydraulic energy accumulators 12a and 12b, which respond to setpoints by giving back a fluid pressure to the braking system, and also give back a fluid pressure in the event of failure, e.g. of the hydraulic pump 6.

Thus, in the event of failure, e.g. of the hydraulic pump 6 or of the inverse proportional valves 8a, 8b, pressure limiters 13a and 13b, which are connected directly to respective ones of the separators 9a and 9b, make it possible to obtain progressive braking of the vehicle until it comes to a complete standstill.

In the safety mode, the hydraulic energy charged in the hydraulic energy accumulators 12a and 12b is released via hydraulic valves that are controlled electrically by the braking automated logic controller 4 and that are disposed in a closed position so as to act on the separators 9a and 9b via the respective pressure limiters 13a and 13b.

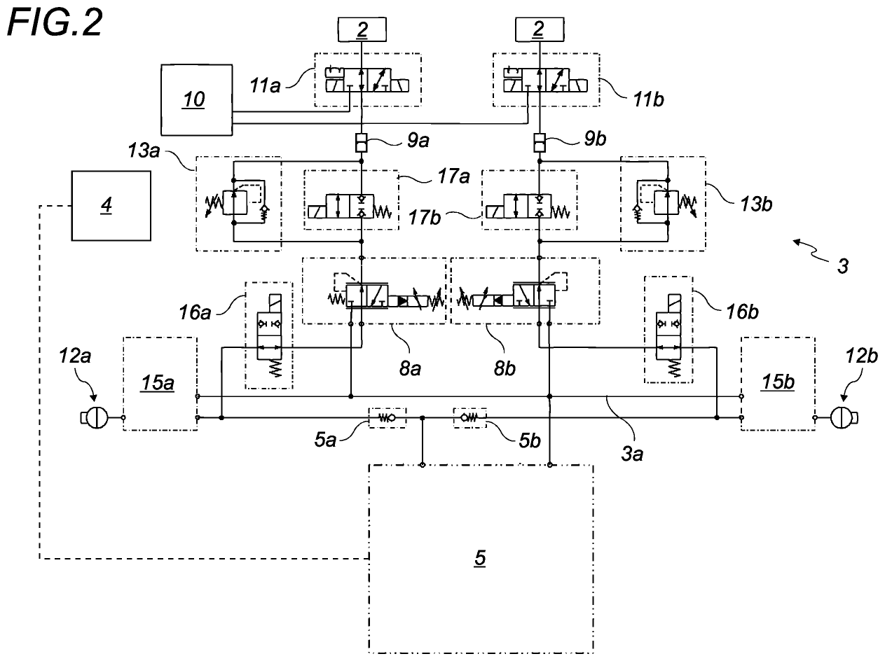

FIG. 2 is a detailed hydraulic diagram of a variant embodiment of the braking system of FIG. 1.

In this detailed variant embodiment, the feed subassembly 5 charges the hydraulic accumulators 12a and 12b via non-return or “check” valves 5a and 5b, and via hydraulic connection modules 15a and 15b. The hydraulic connection modules 15a and 15b are advantageously incorporated into a system for monitoring the energy reserves of the hydraulic accumulators 12a, 12b. A return circuit branch 3a makes it possible to achieve fluid flow communication towards the reservoir 7 of the hydraulic feed subassembly 5.

The hydraulic accumulators 12a and 12b are connected to the respective inverse proportional valves 8a and 8b via respective sealing valves 16a and 16b. Said sealing valves 16a and 16b make it possible to limit the leaks in the hydraulic system that are due to any faults or failures of the inverse proportional valves 8a, 8b, and therefore to reduce the number of times the hydraulic pump 6 is switched on.

The inverse proportional valves 8a and 8b are connected to the separator 9a and 9b via a circuit branch constituted by a parallel connection of an additional sealing valve 17a, 17b and of a pressure limiter 13a, 13b. In the “safety” mode, corresponding to emergency braking, the additional sealing valves 17a, 17b are no longer powered electrically, and are in a closed position as shown in FIG. 2. The hydraulic fluid is then forced to pass through the pressure limiters 13a, 13b.

In an “automatically controlled” mode corresponding to braking that is automatically controlled by the braking automated logical controller 4, the additional sealing valves 17a, 17b are not electrically powered and are in an open position.

The separators 9a and 9b are connected to the respective selectors 11a and 11b that make it possible to switch over from the manual braking mode to an “automatically controlled braking” mode or vice versa. In the variant embodiment shown, the selectors 11a and 11b are valves disposed in an open position corresponding to the automatically controlled mode.

By way of application example, when the additional braking circuit 3 equips two vehicles hitched together to constitute a convoy, the braking automated logic controller 4 of the first vehicle or “tractor vehicle” transmits information to the braking automated logic controller 4 of the second vehicle, which is in trailer mode, in such a manner as to switch the selectors 11a and 11b over into a position corresponding to activating the automatically controlled braking. The manual braking hydraulic circuit 10 of the vehicle in trailer mode is then deactivated.

In operation in the automatically controlled mode, the hydraulic pump 6 charges the hydraulic accumulators 12a and 12b, which deliver the hydraulic pressures necessary for braking. Said hydraulic accumulators 12a and 12b are of high volume in such a manner as to have a hydraulic energy reserve in the event the hydraulic pump 6 fails. The accumulators 12a and 12b are used only to implement the braking in automatically controlled mode and the braking in safety mode.

In operation in the automatically controlled mode, the inverse proportional valves 8a and 8b modulate the braking pressure in the additional hydraulic circuit 3 according to a setpoint delivered by the automated logic controller 4 equipping the vehicle. By way of example, wheel speed sensors, pressure sensors, and accelerometers transmit the necessary information to the braking automated logic controller 4 to enable the braking to be controlled by said braking automated logic controller 4.

In the event of failure, e.g. of the automated logic controller of the vehicle, the sealing valves 16a and 16b and the inverse proportional valves 8a and 8b open while the additional sealing valves 17a and 17b are disposed in a closed state. The hydraulic fluid can then transmit a force to each of the separators 9a and 9b only via the respective one of the pressure limiters 13a and 13b. For example, the pressure limiters 13a and 13b may be configured to limit the pressure to 30 bars, thereby providing moderate safety braking until the vehicle comes to a complete standstill.

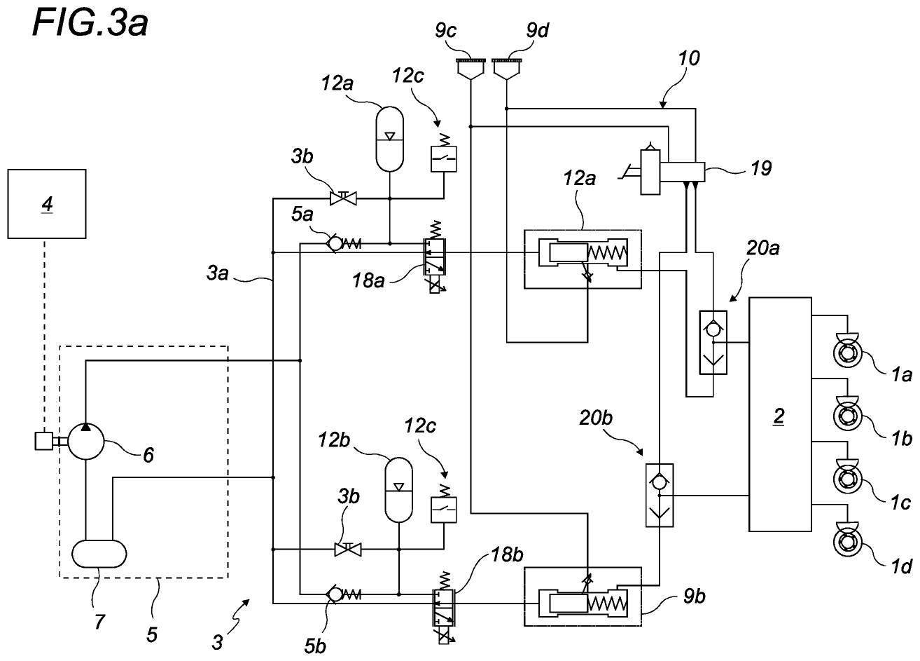

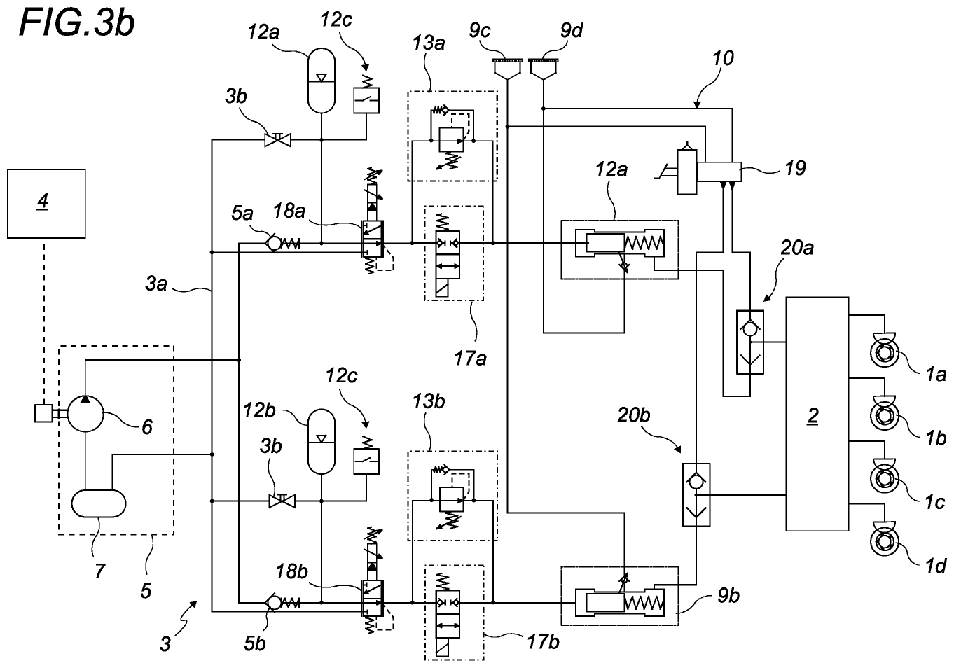

FIG. 3a is a detailed hydraulic diagram of another variant embodiment of the braking system of FIG. 1. In this variant embodiment, the inverse proportional valves 8a and 8b of FIGS. 1 and 2 are replaced by respective ones of proportional valves 18a and 18b. In addition, in this variant embodiment, the manual braking hydraulic circuit 10 may, for example, include a manual braking member associated with a master cylinder 19.

The additional hydraulic circuit 3 and the manual braking circuit 10 are connected to the braking members 1a, 1b, 1c and 1d via a hydraulic “OR” valve. This hydraulic “OR” valve makes it possible to give priority to that one of the additional or manual hydraulic circuits 3, 10 that delivers the higher braking pressure.

In the variant embodiment shown in FIG. 3a, the proportional hydraulic valves 18a and 18b make it possible to actuate the respective separators 9a and 9b via discharging of the hydraulic energy accumulators 12a and 12b. The pressure of the fluid contained in said hydraulic accumulators 12a and 12b is measured by pressure sensors 12c. The hydraulic accumulators 12a and 12b are charged by the hydraulic fluid by means of the hydraulic pump 6, the activation and the speed of rotation of which are advantageously controlled by the braking automated logic controller 4 as a function of the pressure measured by the sensors 12c. When the pressure in the hydraulic accumulators 12a, 12b decreases to below a predetermined low threshold, the braking automated logic controller 4 causes the hydraulic pump 6 to be actuated.

Stopcocks 3b are disposed in hydraulic circuit branches connecting the accumulators 12a and 12b to the return circuit branch 3a. The stopcocks are used only for maintenance operations and are in a shutoff position while the braking system is operating.

The separators 9a and 9b are advantageously connected to respective reservoirs 9c and 9d, containing the second hydraulic fluid, which fluid acts directly on the brake members 1a, 1b, 1c, and 1d.

The additional braking circuit 3, shown in FIG. 3a thus makes it possible to implement automatically controlled braking, in the “automatically controlled mode”, e.g. for a conventional individual vehicle, an autonomous vehicle, or a hitched vehicle configured in trailer mode.

FIG. 3b is a detailed hydraulic diagram of an additional variant embodiment of the braking system of FIG. 1. In this example shown in FIG. 3b, the additional hydraulic circuit 3 differs from the one shown in FIG. 3a, in that, between respective ones of the proportional valves 18a, 18b and respective ones of the separators 9a, 9b, it includes respective hydraulic circuit branches, each of which is constituted by a parallel connection of an additional sealing valve 17a, 17b and of a pressure limiter 13a, 13b.

The additional braking circuit 3, shown in FIG. 3b thus makes it possible to implement automatically controlled braking, referred to as the “automatically controlled mode”, and emergency braking, referred to as the “safety mode”, e.g. for a conventional individual vehicle, an autonomous vehicle, or a hitched vehicle configured in trailer mode.

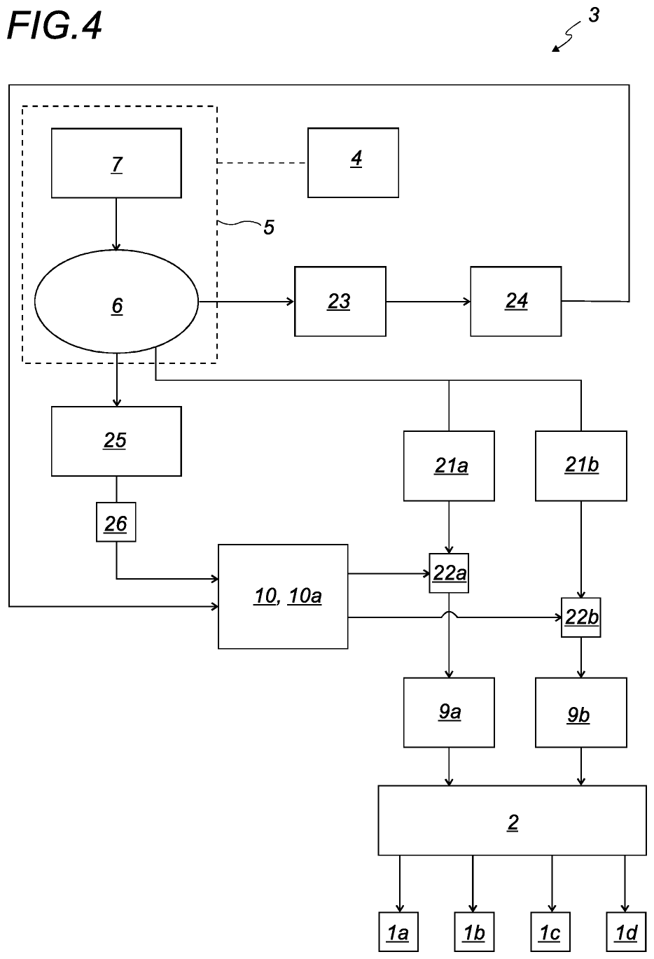

FIG. 4 is a block diagram of another embodiment of the braking system of the invention. In this other embodiment, the hydraulic pressure is stored in hydraulic accumulators 21a and 21b designed for braking in manual mode via the manual braking hydraulic circuit 10 associated with an actuating pedal or an actuating member 10a. The separators 9a and 9b are therefore fed by the respective hydraulic accumulators 21a and 21b via respective proportional valves 22a and 22b. The proportional valves are actuated by the pedal or actuating member 10a.

In an automatically controlled braking mode controlled electrically via the braking automated logic controller 4, a second hydraulic accumulator 23, charged via the hydraulic pump 6 delivers a hydraulic pressure to the actuating member 10a via a proportional valve 24. When the actuating member 10a is actuated in this way, it is said proportional valve 24 that, itself, actuates the proportional valves 22a and 22b to transmit a force to the separators 9a and 9b.

The actuating member 10a is advantageously equipped with a position sensor 10b, the position of which determines the desired braking power by means of a corresponding amplitude of activation of the proportional hydraulic valves 22a and 22b.

The additional hydraulic circuit 3 also includes a safety hydraulic accumulator 25 charged via the hydraulic pump 6 and releasing a hydraulic pressure so as to actuate the actuating member 10a via a pressure limiter 26. The position of the actuating member 10a, as read by the position sensor 10b, also makes it possible to control the proportional valves 22a and 22b and thereby to cause emergency braking to take place by means of the pressure applied to the separator 9a and 9b. The proportional valves 22a and 22b are then in an open state, opening of them not being at its maximum but being sufficient to guarantee degraded braking.

Advantageously, the separators 9a and 9b are connected to respective reservoirs 9c and 9d containing a hydraulic fluid that is compatible with the braking members 1a, 1b, 1c, and 1d, which, in this example are calipers co-operating with brake disks.

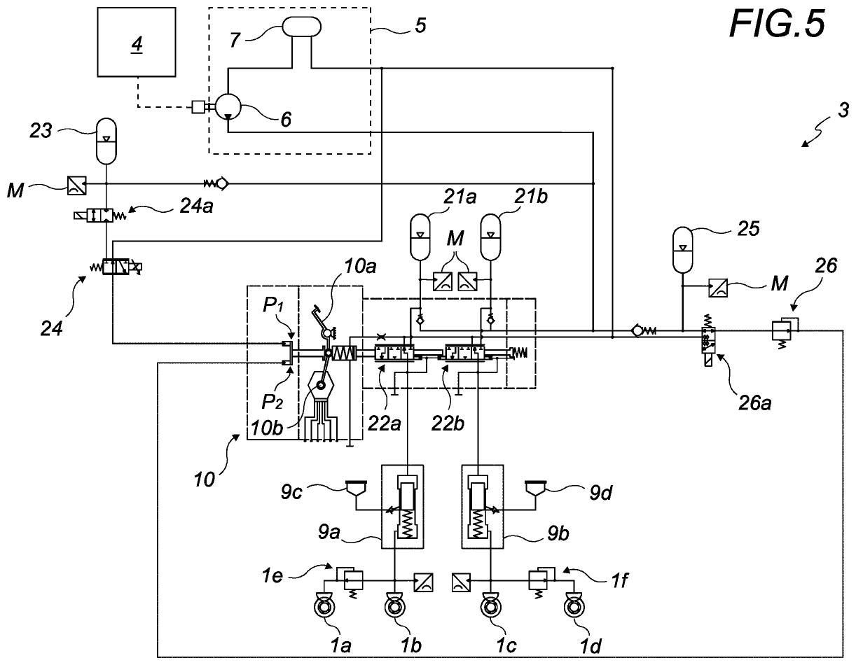

FIG. 5 is a detailed hydraulic diagram of a variant embodiment of the braking system of FIG. 4.

In this variant embodiment, the actuating member 10a is associated with the position sensor 10b. The position sensor 10b delivers information about the position of the actuating member 10a. That information is used, by means of the braking automated logic controller 4, to perform a comparison between the braking power transmitted to the brake members 1a, 1b, 1c, 1d and the theoretical braking power given by the position of said actuating member 10a. Such checking makes it possible, for example, to detect inconsistency between the braking pressure read by pressure sensors at the brake members 1a, 1b, 1c, 1d and the position of the actuating pedal 10a. The checking concerns braking in manual mode and braking in automatically controlled mode. This thus makes it possible to check the structural integrity of said braking system.

The proportional valves 22a and 22b that are of the slide valve type, are interconnected mechanically and are actuated directly by the actuating pedal 10a.

The hydraulic accumulators 21a and 21b and 25 are charged with hydraulic fluid so as to reach a predetermined pressure. Said predetermined pressure is advantageously consultable by means of any pressure measurement and reading device M. It is thus possible, at any time, to monitor or check the hydraulic pressure prevailing inside said accumulators.

During braking, and by means of the accumulators 21a and 21b, the proportional valves 22a and 22b distribute the hydraulic power to the respective separators 9a and 9b.

In manual braking mode, it is the actuating member 10a that determines the position of the proportional valves 22a and 22b and it does so with direct action from a user on said actuating pedal 10a.

In automatically controlled braking mode, it is the proportional valve 24 that releases the hydraulic power of the hydraulic accumulator 23 onto a port P1 of the actuating member 10a. The proportional valve 24 is, in this variant embodiment, controlled electrically by setpoints coming from the braking automated logic controller 4. The hydraulic accumulator 23 is advantageously connected to the proportional valve 24 via a sealing valve 24a, thereby avoiding any hydraulic leakage when the braking in automatically controlled mode is not active.

In the event of failure of the hydraulic pump 6 or of electrical or electronic fault in the braking system, a simple valve 26a makes it possible to release the hydraulic power from a hydraulic accumulator 25 via a pressure limiter 26 towards a second port P2 of the actuating pedal 10a. The actuating pedal then actuates the proportional valves 22a and 22b that, in their turn, release hydraulic power from the hydraulic accumulators 21a and 21b to act on the hydraulic separators 9a and 9b. The simple valve 26a advantageously makes it possible to generate braking before there is no longer any energy reserve in the hydraulic accumulators 21a and 21b or in the event of a fault, e.g. a leak, in the hydraulic circuit or in the event of an electrical/electronic fault.

Advantageously, the hydraulic accumulators 21a and 21b are sufficiently dimensioned to make it possible, for example, for braking to be applied nine successive times in the event the hydraulic pump 6 fails. By way of example, each of hydraulic accumulators 21a and 21b has a volume of 0.5 liters and each of the hydraulic accumulators 23 and 25 has a volume of 0.16 liters for a maximum pressure of 130 bars.

The hydraulic separators 9a and 9b that are known per se are dimensioned to compensate for taking up mechanical clearance appearing in the brake calipers and for compensating for the wear on the brake pads.

The braking automated logic controller 4 also makes it possible automatically to control the pressure prevailing inside the hydraulic accumulators 21a, 21b, 23, and 25 in such a manner as to detect any failure.

Upstream from the brake members 1a and 1d associated with the rear wheels of the vehicle, provision may also be made to have pressure limiters 1e and 1f for a vehicle that does not have a distribution module 2.

The additional hydraulic circuit 3, shown in FIG. 5 thus makes it possible to implement automatically controlled braking, referred to as the “automatically controlled mode”, and emergency braking, referred to as the “safety mode”, e.g. for a conventional individual vehicle, an autonomous vehicle, or a hitched vehicle configured in trailer mode.

By way of an additional variant embodiment, it is possible to integrate a braking intensity distribution module 2 in series between the separators 9a and 9b and the brake members 1a, 1b, 1c and 1d, as shown diagrammatically in FIG. 4.

Naturally, the invention is not limited to the preferred embodiment described above and shown in the various figures, it being possible for the person skilled in the art to make numerous modifications to this embodiment and to imagine other variants. Thus, a technical characteristic or feature described may be replaced with an equivalent technical characteristic or feature without going beyond the scope or the ambit of the invention, as that scope and ambit are defined by the claims.

1. A braking system configured for use on a road motor vehicle, an individual vehicle, an autonomous vehicle, or a vehicle configured in trailer mode or in tractor mode, the braking system configured to actuate brake members associated with the wheels of said vehicle to cause vehicle braking, said system comprising control members for controlling operation of the braking system and a manual braking hydraulic circuit, said braking system further comprising an additional hydraulic circuit equipping the same vehicle and electrically controlled, the control members comprising an electrical braking automated logic controller for generating main or additional braking setpoints, which are transmitted to the additional hydraulic circuit.

2. A braking system according to claim 1, wherein the braking system equips a vehicle configured in trailer mode, in which the additional hydraulic circuit electrically controlled via the braking automated logic controller is activated, said braking automated logic controller being slaved to a master braking automated logic controller of another vehicle.

3. A braking system according to claim 1, further comprising brake fluid separators configured to allow operation with two different brake fluids.

4. A braking system according to claim 1, wherein the additional hydraulic circuit includes at least one accumulator configured to store a hydraulic fluid under a hydraulic pressure suitable for implementing the braking operations.

5. A braking system according to claim 1, wherein the braking automated logic controller includes analysis and/or comparison members configured to detect failure or malfunctioning of the manual braking hydraulic circuit and to generate braking setpoints corresponding to emergency braking of said vehicle by means of the additional braking hydraulic circuit.

6. A braking system according to claim 1, wherein the braking system further comprises a set of sensors configured to measure values of physical parameters of operation and use of said vehicle, said sensors being connected to the braking automated logic controller and operable to transmit the measured values to the braking automated logic controller and to automatically generate braking setpoints for the additional hydraulic circuit, thereby implementing automatic braking.

7. A braking system according to claim 1, wherein the manual braking hydraulic circuit includes a manual braking member, of the brake pedal type, to actuate the braking, and equipped with a position sensor, which delivers information used for making a comparison with the braking power transmitted to the brake members and for thereby checking the structural integrity of said braking system.

8. A braking system according to claim 6, further comprising a selection member configured to select between an autonomous operating mode in which the automatic braking is activated and a manual operating mode in which the manual braking hydraulic circuit is activated.

9. A braking system according to claim 6, wherein the manual braking hydraulic circuit and the additional hydraulic circuit are connected to the brake members via a hydraulic “OR” gate configured to allow priority be given to the hydraulic circuit that has the higher braking hydraulic pressure.

10. A braking system according to claim 1, further comprising a distribution module configured to distribute the braking hydraulic pressure, the module being of the ABS type and/or of the ESP type.

11. A vehicle including a braking system according to claim 1, wherein the vehicle is configured as an individual vehicle or as an autonomous vehicle.

12. An autonomous vehicle including a braking system according to claim 1.

13. A vehicle including a braking system according to claim 1, wherein the vehicle can be configured in trailer mode, in which the additional hydraulic circuit that is electrically controlled via the braking automated logic controller is activated, said braking automated logic controller being slaved to a master braking automated logic controller of another vehicle.

14. A convoy of vehicles that are connected together by means of mechanical or intangible hitching-together, said convoy including a tractor vehicle including a braking system according to claim 1, and at least one vehicle configured in trailer mode, the braking automated logic controller of the tractor vehicle being connected to the braking automated logic controller of the vehicle configured in trailer mode via a wired or wireless communications link, via which the braking setpoints for said vehicle configured in trailer mode pass.

15. A convoy of vehicles that are connected together by means of mechanical or intangible hitching-together, said convoy including a tractor vehicle including a braking system, and at least one vehicle configured in trailer mode according to claim 13, the braking automated logic controller of the tractor vehicle being connected to the braking automated logic controller of the vehicle configured in trailer mode via a wired or wireless communications link, via which the braking setpoints for said vehicle configured in trailer mode pass.
